(19) United States
(12) Patent Application Publication
(10) Pub. No.: US 2014/0268882 A1
(43) Pub. Date: Sep. 18, 2014

(54) Programmable LED Night Light

(71) Applicant: Nguyen Hoan Hoang, Brossard (CA)

(72) Inventor: Nguyen Hoan Hoang, Brossard (CA)

(21) Appl. No.: 14/197,483

(22) Filed: Mar. 5, 2014

Related U.S. Application Data
(60) Provisional application No. 61/791,579, filed on Mar. 15, 2013.

(51) Int. Cl. F21S 8/00

(52) U.S. Cl. CPC F21S 8/035
USPC 362/642; 362/641

(57) ABSTRACT

A programmable night light having a matrix of LEDs as its light source is provided. The present programmable LED night light comprises a panel supporting an LED matrix, a body portion, and a flexible neck extending between the panel and the body portion. The body portion further has a plug, which engages with a conventional electrical outlet, and preferably includes a motion sensor disposed on its front surface. The flexible neck of the present invention allows the orientation of the LED light source to be changed as desired by the user. Furthermore, the LED matrix is programmable via a wirelessly connected electronic device, allowing users to alter the luminosity of the LEDs, change the pattern displayed by the LED matrix, switch the device between a standard night light mode and a projection mode, and have the device respond to a variety of other inputs.

### CROSS REFERENCE TO RELATED APPLICATION

This application claims the benefit of U.S. Provisional Application No. 61/791,579 filed on Mar. 15, 2013, entitled “Smart Night Light.” The above identified patent application is herein incorporated by reference in its entirety to provide continuity of disclosure.

### BACKGROUND OF THE INVENTION

1. Field of the Invention

The present invention relates to night lights. More specifically, the present invention relates to night lights that utilize LEDs and are programmable.

Night lights are ubiquitous in homes having small children, but they fail to provide any utility beyond their basic functionality. Conventional night lights do not include a means to program them to follow a certain schedule; one simply plugs the night light in and the light turns on. This is not desirable because it does not provide users with the degree of control that they have come to expect over their electronic devices. The night light art has failed to take advantage of advances in technology that provides users with the ability to wirelessly control their electronic devices and customize them as they see fit.

Night lights utilizing LEDs as the light source are known in the prior art. Some types of these night lights that are adapted to project images from their LED light sources onto opposing surfaces, however these devices lack a means for wirelessly input and program the output of the LED matrices. Other night lights are able to respond to various inputs and environmental conditions, but they are programmed to respond to those inputs in a set fashion and lack a way to allow the user to customize the function of their night light.

A programmable LED night light is provided. The present LED night light comprises a panel supporting an LED matrix, a body portion, and a flexible neck having a first end connected to the panel and a second end connected to the body portion. The LED matrix is composed of a plurality of aligned LEDs that are individually capable of having their output, in terms of color or intensity, altered. The body portion also has a plug that is capable of engaging with a conventional electrical outlet, thereby providing power to the present invention. An alternative embodiment of the present invention further includes a motion sensor disposed on the front surface of the present invention, which is capable of detecting the presence of movement in the vicinity of the present invention and utilizing that input to modulate the output of the LED matrix. The flexible neck allows the panel supporting the LED matrix to be oriented in any way desired by the user. The present invention further contains a transceiver for wirelessly communicating with an electronic device of the user's preference, such as a laptop or a smartphone, thereby allowing users to wirelessly program the present invention. Users can program the present invention to follow a certain schedule, either altering the luminosity of the LED matrix or altering the pattern displayed by the LED matrix in response to the time and the day, or they can program the present invention to alter the output of the LED matrix in response to motion, as detected by the provided motion sensor. These programmable features can furthermore be combined together to work in concert to give users full control over the function of the present invention.

2. Description of the Prior Art

Devices have been disclosed in the prior art that relate to night lights. These include devices that have been patented and published in patent application publications. These devices generally relate to night lights. The following is a list of devices deemed most relevant to the present disclosure, which are herein described for the purposes of highlighting and differentiating the unique aspects of the present invention, and further highlighting the drawbacks existing in the prior art.

One such device is U.S. Pat. No. 8,128,274 to Chien, which discloses a LED night light that is able to project images generated by the panel of LED lights. Chien utilizes an optic means disposed over the LED lights that has a plurality of variously shaped openings allowing light to shine therethrough and project that image onto a surface. Unlike Chien, the present invention does not utilize an optic means disposed over the LED lights to generate differently-shaped projections. The present invention instead utilizes a programmable matrix of LED lights to generate the projected shapes desired by the user.

Another such device is U.S. Published Patent Application Publication No. 2007/0076439 to Chien, which discloses an LED night light with an interchangeable display unit. Chien comprises a base unit having a plug and a removable display unit having a plurality of variously shaped cutouts allowing light to shine from the base unit therethrough. The use is able to change the image projected from the device by swapping different display units. The present invention utilizes a programmable matrix of LED lights that can alter the image being displayed in real-time, without any need to remove the display panel.

U.S. Published Patent Application Publication No. 2008/0224637 to Parker discloses a night light that automatically alters the color of the light that it emits based on the ambient temperature in the room. The present invention does not include a temperature sensor for controlling the color of the light being emitted and instead includes a means for wirelessly programming the emitted light via a mobile device and a motion sensor that is capable of turning the present invention on or off. The present invention is also able to alter the color emitted by the lights of the LED matrix; however it does so in response to inputs from the user, not from a sensor that detects the ambient temperature in the room.

Another such device is U.S. Published Patent Application Publication No. 2008/0316164 to Tan, which discloses a user-adjustable display device that has a night light mode. The present invention is also programmable by a user; however the present invention may be wirelessly controlled via a mobile device connected to the programmable LED night light through a Bluetooth, WiFi, or another type of wireless connection.

U.S. Published Patent Application Publication No. 2012/0127759 discloses a night light that utilizes a projection system that is capable of rotating 360 degrees in both the horizontal and vertical axes. The present invention utilizes a flexible neck member to change the orientation of the LED light matrix, not a swiveling ball mechanism. Furthermore, the present invention has a means for wirelessly programming the output of the LED light matrix.

A programmable smart night light is provided. The present invention comprises a panel supporting an LED matrix, a body having a plug, and a flexible neck portion connecting the panel and the body. The flexible neck is able to extend, retract, and rotate about its axis in all directions to alter the orientation of the panel. The LED matrix can function as either a standard night light, emitting a low level of light, or it can function as a projector, emitting a high level of light, and project an image from the display panel onto an opposing surface. The image projected by the LED matrix is wirelessly programmable from another electronic device through a Bluetooth connection, WiFi connection, or any other type of wireless connection commonly known in the prior art. The present invention can also be programmed to alter its output based on a schedule or respond to detected motion in a variety of ways.

It substantially diverges in design elements from the prior art and consequently it is clear that there is a need in the art for an improvement to existing night light devices. In this regard the instant invention substantially fulfills these needs.

### SUMMARY OF THE INVENTION

In view of the foregoing disadvantages inherent in the known types of night lights now present in the prior art, the present invention provides a new programmable LED night light wherein the same can be utilized for providing convenience for the user when providing illumination in rooms throughout a user's house.

It is therefore an object of the present invention to provide a new and improved programmable LED night light device that has all of the advantages of the prior art and none of the disadvantages.

It is another object of the present invention to provide a new and improved programmable LED night light device that is capable of providing gentle illumination to a room.

Another object of the present invention is to provide a new and improved programmable LED night light device that is capable of projecting a display image onto a surface, such as a ceiling or a wall.

Another object of the present invention is to provide a new and improved programmable LED night light device that can follow a pre-programmed schedule.

Another object of the present invention is to provide a new and improved programmable LED night light device that has a display consisting of a matrix of LED lights.

Yet another object of the present invention is to provide a new and improved programmable LED night light device that is wirelessly programmable by another electronic device, such as a smart phone or a laptop.

Yet another object of the present invention is to provide a new and improved programmable LED night light device that has a motion detector.

Still yet another object of the present invention is to provide a new and improved programmable LED night light device where the orientation of the light source can be altered.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention.

FIG. 2A shows a perspective view of the present invention demonstrating the range of movement of the flexible neck member.

FIG. 2B shows a perspective view of the present invention demonstrating the range of movement of the flexible neck member.

FIG. 3 shows a perspective view of the present invention projecting an image against a surface.

### DETAILED DESCRIPTION OF THE INVENTION

Reference is made herein to the attached drawings. Like reference numerals are used throughout the drawings to depict like or similar elements of the programmable LED night light. For the purposes of presenting a brief and clear description of the present invention, the preferred embodiment will be discussed as used for illuminating a conventional room. The figures are intended for representative purposes only and should not be considered to be limiting in any respect.

Referring now to FIG. 1, there is shown a perspective view of the present invention. The present programmable LED night light comprises a panel 16 supporting a light-emitting diode (LED) matrix 11, a body portion 14, and a flexible neck portion 13 connecting the panel 16 and the body portion 14. The body portion 14 preferably has a motion sensor 17 disposed on its front surface and a plug 15 extending from its back surface. The present invention is designed to be plugged into any type of outlet, such as a conventional 120 V AC outlet or a 240 V AC outlet, and as such the plug 15 may be provided in either two or three-prong formats. The body portion 14 comprises a housing containing the various electrical components and the necessary microcontrollers to transfer power from the outlet to the LED matrix 11, to maintain the present invention's ability to wirelessly communicate with another electronic device, and to power and monitor the monitor sensor. The body portion 14 is preferably composed of hard plastic and may be provided in a number of different shapes, sizes, and configurations.

The LED matrix 11 is consists of a plurality of LED lights 12 arranged in a series of rows The LED lights 12 may be arranged in evenly aligned rows, staggered rows, or any other arrangement. The LED lights 12 of the present invention are preferably multi-color LEDS and may comprise di-, tri-, or tetrachromatic white LEDs, allowing each individual LED light 12 to produce a number of different colors. The LED matrix may be controlled by a microcontroller or a control subsystem to relay commands from the transceiver to the LED matrix. The microcontroller or the control subsystem of the present invention may utilize pulse width modulation (PWM) to have the LEDs produce an even greater number of colors. It is submitted that this method of modulating the color of an LED, such as an RGB LED, using PWM is well known in the prior art. The present invention preferably uses RGB white LEDs and PWM to produce a wide spectrum of colors. However, no claim is made as to the precise type of LED utilized as the present invention may further include phosphor-based LEDs, organic LEDs, and quantum dot LEDs, among other types. In an alternative embodiment of the present invention, rather than having an LED matrix 11 composed of multi-color LEDs, the LED matrix 11 may instead be composed of alternating single-color LEDs.

As depicted, the panel 16 supporting the LED lights 12 of the LED matrix 11 are disposed on a rectangular, substantially planar member. However, the panel 16 may be arranged in any shape, may have any size, and may have any number of LED lights 12 disposed thereon. In an alternative embodiment, the panel 16 is composed of flexible plastic material, allowing the curvature of the panel to be altered and thereby altering the orientation of the light or the displayed image emitted from the LED matrix 11.

The present invention contains a transceiver for receiving wireless commands from another electronic device, such as a smart phone or a laptop. The other electronic device can access and program the present invention via a user interface from an application on the electronic device. The present invention can be programmed to follow a certain schedule and react to movement or lack of movement in the vicinity of the present night light. The programming can either alter the intensity of the LED lights 12, alter the image displayed by the LED matrix 11, or alter the pattern of the LED lights 12 in response to the programmed variables or stimuli. Therefore, the LED matrix 11 of the present invention can be programmed in a number of different ways. For example, the present night light can be programmed to automatically turn on at 8:00 PM and automatically turn off at 6:00 AM, thereby saving power. The present night light can also be programmed to automatically turn on if the motion sensor 17 detects movement. The LED matrix 11 of the present invention can also be programmed to change the displayed image by the dot matrix of LED lights 12 in response to a set schedule or movement.

The colors and patterns of the LED lights 12 can be altered using a connected electronic device, using a user interface, to generate different pictures. An electronic device can connect to the present invention via Bluetooth, WiFi, ZigBee, or any other type of wireless connection commonly known in the prior art. The resolution of the resultant image is dependent upon the number of LED lights 12 in the matrix 11. A user can use the user interface from an application on another electronic device in communication with the present programmable LED night light to paint, draw, or otherwise program the pattern and colors of the LED lights 12 to generate images or other designs as the user may wish. The pattern and color of the image is then transferred wirelessly to the present programmable LED night light, which then either immediately displays the transferred image or saves it for display at another programmed time. The present invention further includes a memory unit for storing a number of light patterns. These stored patterns can either be displayed individually, or the present invention can be programmed to display the light patterns as a slideshow with a preset time interval. The slideshow functionality of the device can also be programmed to respond to other inputs, such as motion detected by the motion sensor 17.

The LED matrix 11 can be shifted between a standard night light mode, in which the intensity of the LED lights 12 is minimal and it serves as a relatively conventional night light, and a projection mode. In the projection mode, the intensity of the LED lights 12 is increased such that the present programmable LED night light is able to project the displayed image onto an opposing surface, such as a ceiling or a wall. The projectable, programmable image provides users with a means for entertaining and making their children feel safe in a dark room, increasing the likelihood that the child will be able to fall asleep.

Referring now to FIGS. 2A and 2B, there are shown perspective views of the present invention demonstrating the range of movement of the flexible neck member. The flexible neck 13 has a first end connected to the panel 16 and a second end connected to the body portion 14. The flexible neck 13 is composed of a flexible, moldable material, such as flexible metal conduit material or moldable plastic polymer material, which is able to hold its shape and bend in any direction, 360 degrees in both the vertical and horizontal axes. Furthermore, the flexible neck 13 retains the position that the user places it in, allowing the user to alter the orientation of the panel 16 and thereby direct the light emitted from the LED matrix 11 in any way that the user wishes. The second end of the flexible neck 13 is preferably disposed within a neck housing 18 extending from the body portion 14. The flexible neck 13 can extend from and retract into the neck housing 18, further providing users with options for customizing the orientation of the panel 16. It is submitted that this type of flexible member is well known in the art.

Referring now to FIG. 3, there is shown a perspective view of the present invention projecting an image against a surface. The LED matrix 11 of the present invention can be programmed to display an image and project said image 51 against an opposing surface 52, such as a ceiling or a wall. The present programmable LED night light can be programmed to display and project an image 51 via a wirelessly connected electronic device.

Users will preferably utilize a downloaded application to interact and program the present programmable LED night light. The application can include a means for adjusting the intensity of the LED lights, altering the pattern or image displayed by the LED light matrix, programming the device to respond to motion sensor data, switch between the conventional night light and projection modes, and a host of other features. The present invention can communicate with the user's electronic device via a transceiver contained within the housing, which is able to send and receive signals wirelessly, such as through a WiFi network or through a Bluetooth connection with the electronic device. The transceiver is able to communicate input received wirelessly from the electronic device to selectively alter both the color and intensity of every individual LED light contained within the matrix, forming an overall pattern or image displayed thereon. The present invention may then be switched to a projection mode, which increases the intensity of the LED lights and allows the image displayed thereon to be projected onto an opposing surface 52.

When in use, the user can directly interact and alter the output of the present invention in real-time via a wirelessly connected electronic device using the proper application. However, the present invention can automatically respond to pre-programmed conditions without further input from the user, such as following a set schedule or reacting in certain ways to motion detected via the motion sensor. The user's wireless input is detected by a transceiver, which then relays the input to the control subsystem. The control subsystem then either transfers the input to the memory unit for storage or transfers the input directly to the LED matrix for immediate display. This allows the user to either directly alter the output of the LED matrix in real time or establish programmed conditions to be executed at a later time. The pre-programmed conditions can include responding to motion detected by the motion sensor or following a certain schedule. The memory unit can also store a plurality of patterns to be displayed on the LED matrix in response to the pre-programmed conditions, allowing users to program certain features such as displaying a slideshow of the stored images when motion is not detected for a certain period of time or altering the pattern displayed by the LED matrix depending upon the time of the day. The control subsystem can also transmit commands to the LED matrix to switch the LED matrix between a night light mode, wherein the device displays a pattern at a moderate luminosity, and a projection mode, wherein the intensity of the LED matrix is increased to the point that it is capable of projecting the pattern displayed thereon onto opposing surfaces. The LED matrix can be switched between the night light and the projection modes in response to either real-time wireless input or pre-programmed conditions.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A programmable LED night light, comprising:
a panel supporting a matrix composed of LED lights;
said LED matrix generating an output comprising a pattern or an image displayed thereon;
a body portion having an electrical outlet plug disposed thereon;
a flexible neck having a first end and a said second, said first end connected to said panel and said second end connected to said body portion;
a transceiver for wirelessly communicating with an electronic device;
wherein said transceiver is able to relay inputs from said electronic device to said LED matrix to alter said LED matrix output.

2. The programmable LED night light of claim 1, further comprising:
a motion sensor disposed on said body portion;
wherein said motion sensor is able to communicate with and alter the output of said LED matrix.

3. The programmable LED night light of claim 1, wherein said LED lights comprise RGB LEDs.

4. The programmable LED night light of claim 3, wherein said RGB LEDs are modulated via PWM.

5. The programmable LED night light of claim 1, wherein said LED lights comprise phosphor-based LEDs.

6. The programmable LED night light of claim 1, wherein said LED lights comprise organic LEDs.

7. The programmable LED night light of claim 1, wherein said LED lights comprise quantum-dot LEDs.

8. The programmable LED night light of claim 1, wherein said LED matrix may be programmed to project an image displayed thereon against an opposing surface.

9. The programmable LED night light of claim 1, wherein said flexible neck comprises flexible metal conduit material.

10. The programmable LED night light of claim 1, wherein said LED matrix output can be programmed to follow a user-programmed schedule.

11. The programmable LED night light of claim 1, wherein a user can upload an image from an electronic device to said programmable LED night light to be displayed on said LED matrix.
